(19) United States
(12) Patent Application Publication
(10) Pub. No.: US 2026/0339457 A1
(43) Pub. Date: Oct. 29, 2026

(54) TOUCH PANEL DRIVING METHOD AND TOUCH PANEL DRIVING SYSTEM

(71) Applicant: HIMAX TECHNOLOGIES LIMITED, Tainan City (TW)

(72) Inventors: Wen-Sen SU, Tainan City (TW); Rong-Sing HUANG, Tainan City (TW); Wen-Hsiu CHUNG, Tainan City (TW); Li Lin LIU, Tainan City (TW); Shen-Feng TAI, Tainan City (TW)

(21) Appl. No.: 19/186,615

(22) Filed: Apr. 23, 2025

(51) Int. Cl. G06F 3/041; G06F 3/044

(52) U.S. Cl. CPC G06F 3/04166; G06F 3/0446

(57) ABSTRACT

A touch panel driving method, including: receiving a base capacitance and a touch capacitance by an analog-to-digital converter (ADC) in response to a touch event occurring on a touch panel; comparing a sum of the base capacitance and the touch capacitance with a preset capacitance threshold by a touch detection circuitry; staying the touch detection circuitry in an idle mode in response to the sum of the base capacitance and the touch capacitance being less than the preset capacitance threshold; and switching the touch detection circuitry to an active mode in response to the sum of the base capacitance and the touch capacitance being larger than or equal to the preset capacitance threshold, in which the touch detection circuitry utilizes a mutual all drive way to drive at least one channel of the touch panel.

### BACKGROUND

### Technical Field

The present disclosure relates to a driving method and a driving system, and more particularly to a touch panel driving method and a touch panel driving system.

### Description of Related Art

With the current demand for electronic products to be thin, light, and flexible, the parasitic capacitance between the touch panel and the display panel is getting larger and larger, making it difficult for touch panels implemented utilizing a traditional self-driving way to meet the requirements of both power saving and high touch sensitivity. This is because when the parasitic capacitance getting larger, the signal-to-noise ratio (SNR) of the touch panel implemented by the self-driving way becomes lower, resulting in the touch panel in the power saving mode not being able to have high touch sensitivity at the same time.

### SUMMARY

The object of the present disclosure is to propose a multi-channel mutual all drive way to replace the common self-driving way for a touch detection circuitry to drive a touch panel, so that even when the resistor-capacitor loading of the touch panel is heavy, the touch detection circuitry can still receive normal signals instead of too small signals in response to a touch event occurring on the touch panel. In this way, the high touch sensitivity of the touch panel can be achieved while saving power.

One aspect of the present disclosure relates to a touch panel driving method, including: receiving a base capacitance and a touch capacitance by an analog-to-digital converter (ADC) in response to a touch event occurring on a touch panel, in which the ADC is electrically connected to the touch panel; comparing a sum of the base capacitance and the touch capacitance with a preset capacitance threshold by a touch detection circuitry, in which the touch detection circuitry is electrically connected to the touch panel; staying the touch detection circuitry in an idle mode in response to the sum of the base capacitance and the touch capacitance being less than the preset capacitance threshold; and switching the touch detection circuitry to an active mode in response to the sum of the base capacitance and the touch capacitance being larger than or equal to the preset capacitance threshold, in which the touch detection circuitry utilizes a mutual all drive way to drive at least one channel of the touch panel.

In accordance with one or more embodiments of the present disclosure, a mutual loading of the touch panel driven in the mutual all drive way by the touch detection circuitry is less than a self loading of the touch panel driven in a self-driving way by the touch detection circuitry.

In accordance with one or more embodiments of the present disclosure, a signal-to-noise ratio (SNR) of the touch panel driven in the mutual all drive way by the touch detection circuitry is larger than a SNR of the touch panel driven in the self-driving way by the touch detection circuitry.

In accordance with one or more embodiments of the present disclosure, the touch detection circuitry utilizes a mutual all drive way to simultaneously drive each of the at least one channel at a transmitting (TX) side of the touch panel in a first cycle.

In accordance with one or more embodiments of the present disclosure, the touch detection circuitry utilizes a mutual all drive way to simultaneously drive each of the at least one channel at a receiving (RX) side of the touch panel in a second cycle.

In accordance with one or more embodiments of the present disclosure, the first cycle is a different cycle from the second cycle.

In accordance with one or more embodiments of the present disclosure, the ADC receives signals from each of the at least one channel at the RX side in response to the touch detection circuitry transmitting the signals to each of the at least one channel at the TX side.

In accordance with one or more embodiments of the present disclosure, the ADC receives signals from each of the at least one channel at the TX side in response to the touch detection circuitry transmitting the signals to each of the at least one channel at the RX side.

In accordance with one or more embodiments of the present disclosure, each of the at least one channel at the RX side is a different channel from each of the at least one channel at the TX side.

Another aspect of the present disclosure relates to a touch panel driving system, which includes a touch panel, an analog-to-digital converter (ADC), and a touch detection circuitry. The ADC is configured to receive a base capacitance and a touch capacitance in response to a touch event occurring on the touch panel, in which the ADC is electrically connected to the touch panel. The touch detection circuitry is configured to compare a sum of the base capacitance and the touch capacitance with a preset capacitance threshold, in which the touch detection circuitry is electrically connected to the touch panel. The touch detection circuitry stays in an idle mode in response to the sum of the base capacitance and the touch capacitance being less than the preset capacitance threshold. The touch detection circuitry switches to an active mode in response to the sum of the base capacitance and the touch capacitance being larger than or equal to the preset capacitance threshold. The touch detection circuitry utilizes a mutual all drive way to drive at least one channel of the touch panel.

### BRIEF DESCRIPTION OF THE DRAWINGS

This disclosure can be more fully understood by reading the following detailed description of the embodiments, with reference made to the accompanying drawings as follows:

FIG. 1 is a flowchart of a touch panel driving method in accordance with some embodiments of the present disclosure.

FIG. 2 is a schematic diagram of a touch panel driven in a self-driving way by a touch detection circuitry in accordance with some embodiments of the present disclosure.

FIG. 3A is a schematic diagram of the comparison between a sum of capacitance received by an ADC and a preset capacitance threshold in the case of a touch panel having normal RC loading.

FIG. 3B is a schematic diagram of a comparison between a sum of capacitance received by an ADC and a preset capacitance threshold in the case of a touch panel having heavy RC loading.

FIG. 4 is a schematic diagram of a touch panel driven in a multi-channel mutual all drive way by a touch detection circuitry in accordance with some embodiments of the present disclosure.

FIG. 5 is a schematic diagram of a touch panel driven in a multi-channel mutual all drive way by a touch detection circuitry in accordance with some embodiments of the present disclosure.

FIG. 6 is a functional block diagram of a touch panel driving system in accordance with some embodiments of the present disclosure.

### DETAILED DESCRIPTION

Reference will now be made in detail to the present embodiments of this disclosure, examples of which are illustrated in the accompanying drawings. Wherever possible, the same reference numbers are utilized in the drawings and the description to refer to the same or like parts. The verb “couple” and its conjugated forms means to complete any type of required junction, including electrical, mechanical, or fluid, to form a singular object from two or more previously non-joined objects.

The resistor-capacitor (RC) loading of touch panels produced by different panel manufacturers may be different, depending on the touch panel manufacturing process, design method or other factors. As today's electronic products are required to be thin, light, and flexible, the parasitic capacitance between the touch panel and the display panel is getting larger and larger, which increases the RC loading of the touch panel.

Under the condition of utilizing charging and discharging way to capture signals, the signals captured by the touch detection circuitry may be different. That is, the signals captured by the touch detection circuitry may be larger or smaller than normal signals.

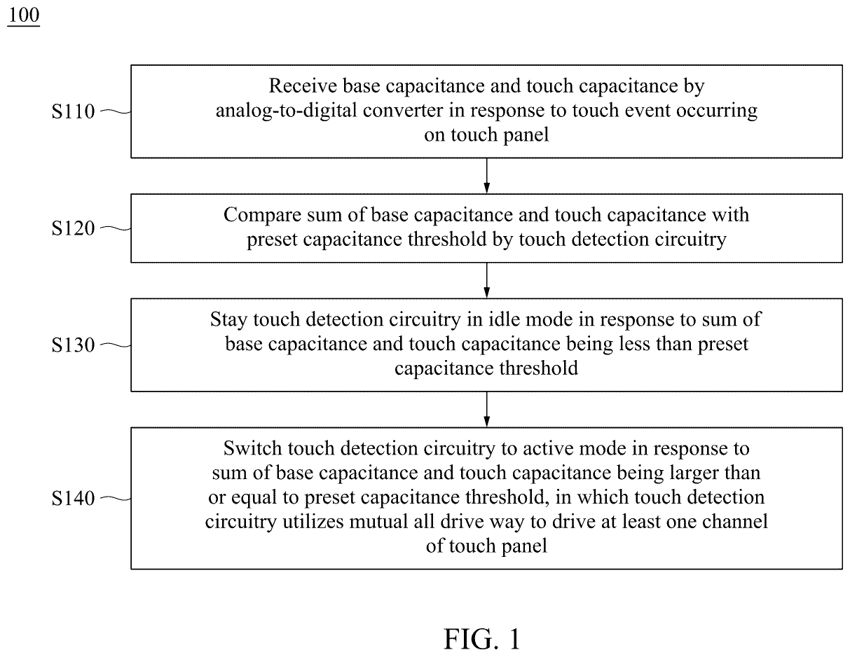

FIG. 1 is a flowchart of a touch panel driving method 100 in accordance with some embodiments of the present disclosure. The touch panel driving method 100 includes steps S110 to S140.

Step S110: receive a base capacitance and a touch capacitance by an analog-to-digital converter (ADC) in response to a touch event occurring on a touch panel, in which the ADC is electrically connected to the touch panel.

Step S120: compare a sum of the base capacitance and the touch capacitance with a preset capacitance threshold by a touch detection circuitry, in which the touch detection circuitry is electrically connected to the touch panel.

Step S130: stay the touch detection circuitry in an idle mode in response to the sum of the base capacitance and the touch capacitance being less than the preset capacitance threshold.

Step S140: switch the touch detection circuitry to an active mode in response to the sum of the base capacitance and the touch capacitance being larger than or equal to the preset capacitance threshold, in which the touch detection circuitry utilizes a mutual all drive way to drive at least one channel of the touch panel.

The following paragraphs describe the implementation method of each step (including steps S110 to S140) in conjunction with FIGS. 1 to 6.

The touch detection circuitry may be divided into an idle mode and an active mode in design. The touch detection circuit may spend less time scanning the touch panel in the idle mode, thereby achieving power saving effect. Most common touch detection circuits utilize a self-driving way to drive the touch panel to achieve the purpose of power saving.

It should be noted that the self-driving way is defined as the following: after the touch detection circuitry driving a channel on one side (such as RX side or TX side) of the touch panel to transmit signals, the ADC utilizes the same channel on the same side of the touch panel to receive signals. On the other hand, the mutual all drive way is defined as the following: after the touch detection circuitry simultaneously driving one or more channels on one side of the touch panel to transmit signals, the ADC simultaneously utilizes another one or more channels on the other side of the touch panel to receive signals.

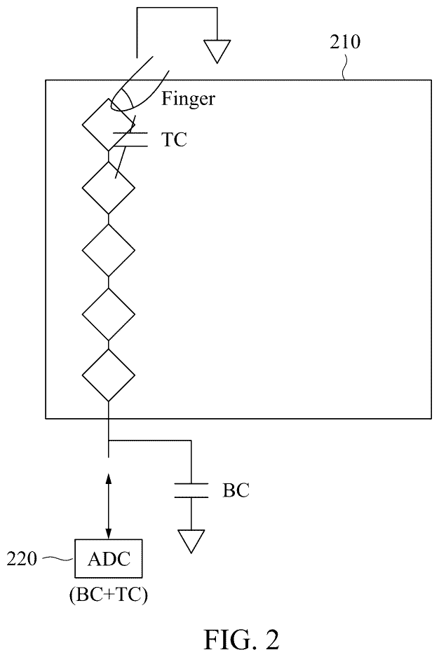

FIG. 2 is a schematic diagram of a touch panel 210 driven in a self-driving way by a touch detection circuitry (not shown in FIG. 2) in accordance with some embodiments of the present disclosure. In one embodiment shown in FIG. 2, after the touch detection circuitry driving a channel on one side (such as the lower side of the touch panel 210 in FIG. 2) of the touch panel 210 to transmit signals, the ADC 220 utilizes the same channel on the same side of the touch panel 210 to receive signals. Further, before a touch event occurring on the touch panel 210 (such as the touch panel 210 touched by a human finger), the ADC 220 only receives a base capacitance (shown as BC in FIG. 2). After the touch event occurring on the touch panel 210, the ADC 220 may simultaneously receive the base capacitance and a touch capacitance (shown as TC in FIG. 2).

However, although the touch panel driven in the self-driving way is power-saving, the signal-to-noise ratio (SNR) of the touch panel driven by the self-driving way may be reduced in response to the RC loading of the touch panel being heavy, making the touch sensitivity of the touch panel also reduced (higher SNR means higher touch sensitivity). That is, it is difficult for a touch panel driven by a self-driving way to meet the requirements of both power saving and high touch sensitivity. In other words, the touch panel driven by the self-driving way may be unusable in response to the RC loading of the touch panel being heavy.

In one embodiment of the present disclosure, the touch detection circuitry switches from the idle mode to the active mode in response to a touch event occurring on the touch panel (such as the touch panel touched by a human finger). The touch detection circuitry then starts to perform full panel scanning on the touch panel to detect the position of the finger on the touch panel to report the coordinate point. In specific, the ADC which electrically connected to the touch panel receives the base capacitance and the touch capacitance in response to a touch event occurring on the touch panel. Then, the touch detection circuitry which also electrically connected to the touch panel compares a sum of the base capacitance and the touch capacitance with a preset capacitance threshold. After the comparison, the touch detection circuitry stays in the idle mode in response to the sum of the base capacitance and the touch capacitance being less than the preset capacitance threshold. Otherwise, the touch detection circuitry switches to the active mode in response to the sum of the base capacitance and the touch capacitance being larger than or equal to the preset capacitance threshold.

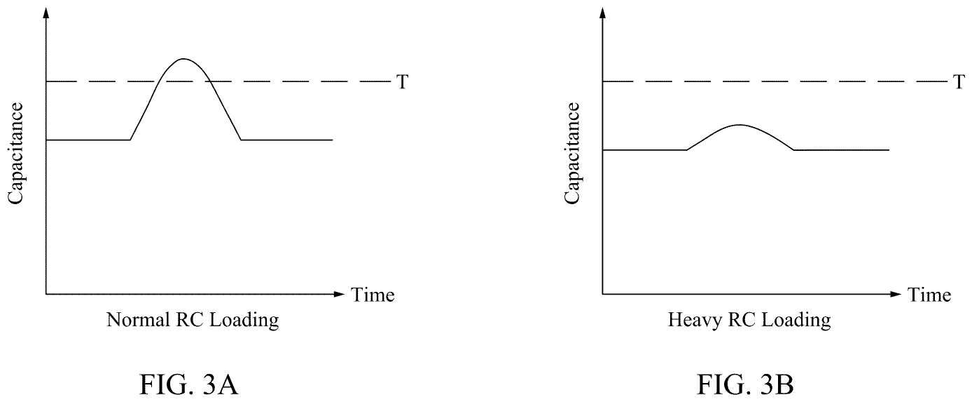

However, in other embodiments of the present disclosure, the touch detection circuitry which should have switched to the active mode may stay in the idle mode. This is because when the touch panel driven by the self-driving way has heavy RC loading, the sum of the base capacitance and the touch capacitance received by the ADC changes from being higher than the preset capacitance threshold (shown as T in FIG. 3A and FIG. 3B) to being lower than the preset capacitance threshold, as illustrated in FIG. 3A and FIG. 3B, causing the touch detection circuitry to still spend less time scanning the touch panel, thereby making the touch sensitivity of the touch panel reduced.

It should be noted that the touch sensitivity of the touch panel gets higher in response to the touch detection circuitry being in the active mode, and the touch sensitivity of the touch panel gets lower in response to the touch detection circuitry being in the idle mode.

Therefore, the present disclosure purposes a multi-channel mutual all drive way for driving the touch panel, replacing the common self-driving way. Because of a mutual loading of the touch panel driven in the multi-channel mutual all drive way is less than a self loading of the touch panel driven in a self-driving way, the SNR of the touch panel driven by the self-driving way may not be significantly reduced. That is, the touch panel driven by the multi-channel mutual all drive way may meet the requirements of both power saving and high touch sensitivity.

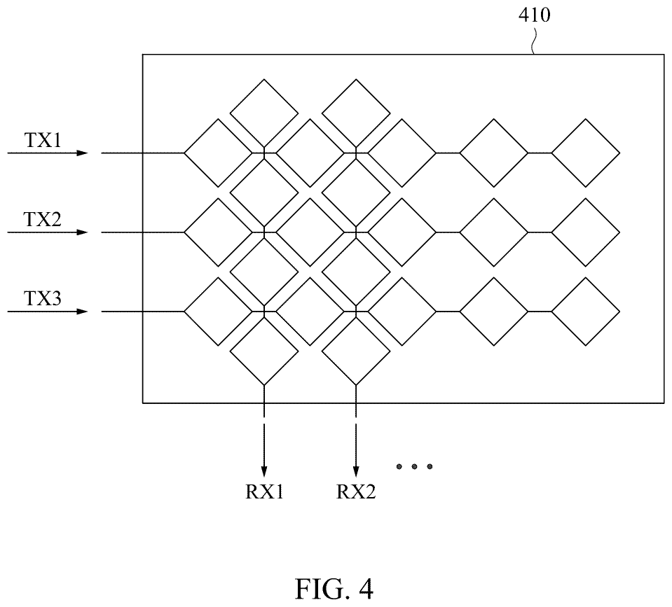

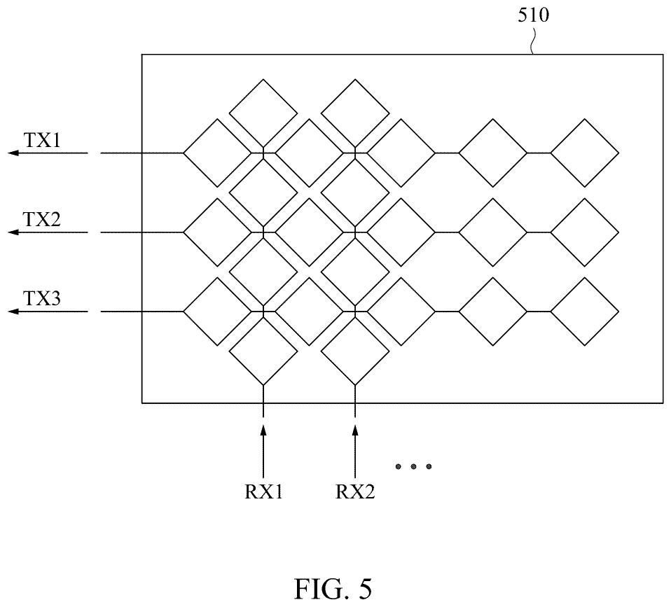

There are many ways for the touch detection circuitry to drive the touch panel. In one embodiment shown in FIG. 4, the touch detection circuitry (not shown in FIG. 4) drives each of channels at the TX side of the touch panel 410 in sequence, and does not drive any of the channels at the RX side of the touch panel 410. In another embodiment shown in FIG. 4, the touch detection circuitry utilizes the multi-channel mutual all drive way to simultaneously drive all channels at the TX side of the touch panel 410 in a first cycle, and simultaneously drive all channels at the RX side of the touch panel 410 in a next cycle (that is, a second cycle). It should be noted that the first cycle is a different cycle from the second cycle in the embodiment shown in FIG. 4. In one embodiment shown in FIG. 5, the touch detection circuitry only drives channels at the RX side of the touch panel. In another embodiment shown in FIG. 5, the touch detection circuitry (not shown in FIG. 5) drives channels at the RX side of the touch panel 510 in a first cycle, and drives channels at the TX side of the touch panel 510 in a next cycle (that is, a second cycle). It should also be noted that the first cycle is a different cycle from the second cycle in the embodiment shown in FIG. 5.

It should be noted that the SNR of the touch panel driven in the multi-channel mutual all drive way by the touch detection circuitry is larger than the SNR of the touch panel driven in the self-driving way by the touch detection circuitry. This is the main reason that the present disclosure purposes the multi-channel mutual all drive way to replace the common self-driving way for the touch detection circuitry to drive the touch panel.

In one embodiment shown in FIG. 4, the touch detection circuitry utilizes the multi-channel mutual all drive way to simultaneously drive all channels of the TX side (only channels TX1 to TX3 shown in FIG. 4 as an example) of the touch panel 410 in a first cycle to utilize channels TX1 to TX3 to transmit signals. Then, the touch detection circuitry simultaneously drives all channels of the RX side (only channels RX1 and RX2 shown in FIG. 4 as an example) of the touch panel 410 in a next cycle (that is, a second cycle), and the ADC (not shown in FIG. 4) simultaneously receives signals transmitted from all channels of the TX side through all channels of the RX side.

It should be noted that each of the channels at the RX side of the touch panel 410 shown in FIG. 4 is a different channel from each of the channels at the TX side of the touch panel 410 shown in FIG. 4.

In one embodiment shown in FIG. 5, the touch detection circuitry utilizes the multi-channel mutual all drive way to simultaneously drive all channels of the RX side (only channels RX1 and RX2 shown in FIG. 5 as an example) of the touch panel 510 in a first cycle to utilize channels RX1 and RX2 to transmit signals. Then, the touch detection circuitry simultaneously drives all channels of the TX side (only channels TX1 to TX3 shown in FIG. 5 as an example) of the touch panel 510 in a next cycle (that is, a second cycle), and the ADC (not shown in FIG. 5) simultaneously receives signals transmitted from all channels of the RX side Then, the touch detection circuitry drives all channels of the TX side (only channels TX1 to TX3 shown in FIG. 5 as an example) of the touch panel 510 in a next cycle (that is, a second cycle), and the ADC simultaneously receives signals transmitted from all channels of the RX side through all channels of the TX side.

It should be noted that each of the channels at the RX side of the touch panel shown in FIG. 5 is a different channel from each of the channels at the TX side of the touch panel shown in FIG. 5.

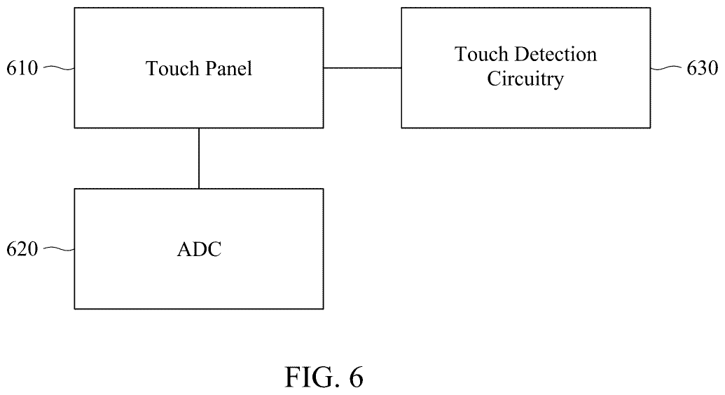

FIG. 6 is a functional block diagram of a touch panel driving system 600 in accordance with some embodiments of the present disclosure. The touch panel driving system 600 includes a touch panel 610, an ADC 620, and a touch detection circuitry 630. The ADC 620 is configured to receive a base capacitance and a touch capacitance in response to a touch event occurring on the touch panel 610, in which the ADC 620 is electrically connected to the touch panel 610. The touch detection circuitry 630 is configured to compare a sum of the base capacitance and the touch capacitance with a preset capacitance threshold, in which the touch detection circuitry 630 is electrically connected to the touch panel 610. The touch detection circuitry 630 may stay in an idle mode in response to the sum of the base capacitance and the touch capacitance being less than the preset capacitance threshold. The touch detection circuitry 630 may switch to an active mode in response to the sum of the base capacitance and the touch capacitance being larger than or equal to the preset capacitance threshold. The touch detection circuitry 630 may utilize a mutual all drive way to drive at least one channel of the touch panel 610.

The implementation of the touch panel 610, the ADC 620, and the touch detection circuitry 630 of the touch panel driving system 600 has been described in detail in steps S110 to S140 of the touch panel driving method 100, and will not be described herein.

As can be seen from the above description, the touch panel driving method and the touch panel driving system propose a multi-channel mutual all drive way to replace the common self-driving way for a touch detection circuitry to drive a touch panel, so that even when the resistor-capacitor loading of the touch panel is heavy, the touch detection circuitry can still receive normal signals instead of too small signals in response to a touch event occurring on the touch panel. In this way, the high touch sensitivity of the touch panel can be achieved while saving power.

It will be apparent to those skilled in the art that various modifications and variations can be made to the structure of the present disclosure without departing from the scope or spirit of this disclosure. In view of the foregoing, it is intended that the present disclosure cover modifications and variations of this disclosure provided they fall within the scope of the following claims.

1. A touch panel driving method, comprising:
receiving a base capacitance and a touch capacitance by an analog-to-digital converter (ADC) in response to a touch event occurring on a touch panel, wherein the ADC is electrically connected to the touch panel;
comparing a sum of the base capacitance and the touch capacitance with a preset capacitance threshold by a touch detection circuitry, wherein the touch detection circuitry is electrically connected to the touch panel;
staying the touch detection circuitry in an idle mode in response to the sum of the base capacitance and the touch capacitance being less than the preset capacitance threshold; and
switching the touch detection circuitry to an active mode in response to the sum of the base capacitance and the touch capacitance being larger than or equal to the preset capacitance threshold,
wherein the touch detection circuitry utilizes a mutual all drive way to simultaneously drive transmitting (TX) channels of the touch panel in a first cycle and then simultaneously drive receiving (RX) channels of the touch panel in a second cycle.

2. The touch panel driving method of claim 1, wherein a mutual loading of the touch panel driven in the mutual all drive way by the touch detection circuitry is less than a self loading of the touch panel driven in a self-driving way by the touch detection circuitry.

3. The touch panel driving method of claim 2, wherein a signal-to-noise ratio (SNR) of the touch panel driven in the mutual all drive way by the touch detection circuitry is larger than a SNR of the touch panel driven in the self-driving way by the touch detection circuitry.

4-5. (canceled)

6. The touch panel driving method of claim 1, wherein the first cycle is a different cycle from the second cycle.

7. The touch panel driving method of claim 1, wherein the ADC receives signals from the RX channels in response to the touch detection circuitry transmitting the signals to the TX channels.

8. The touch panel driving method of claim 7, wherein the ADC receives signals from the TX channels in response to the touch detection circuitry transmitting the signals to the RX channels.

9. The touch panel driving method of claim 8, wherein the RX channels are different from the TX channels.

10. A touch panel driving system, comprising:
a touch panel;
an analog-to-digital converter (ADC) configured to receive a base capacitance and a touch capacitance in response to a touch event occurring on the touch panel, wherein the ADC is electrically connected to the touch panel; and
a touch detection circuitry configured to compare a sum of the base capacitance and the touch capacitance with a preset capacitance threshold, wherein the touch detection circuitry is electrically connected to the touch panel,
wherein the touch detection circuitry stays in an idle mode in response to the sum of the base capacitance and the touch capacitance being less than the preset capacitance threshold,
wherein the touch detection circuitry switches to an active mode in response to the sum of the base capacitance and the touch capacitance being larger than or equal to the preset capacitance threshold,
wherein the touch detection circuitry utilizes a mutual all drive way to simultaneously drive transmitting (TX) channels of the touch panel in a first cycle and then simultaneously drive receiving (RX) channels of the touch panel in a second cycle.

11. The touch panel driving system of claim 10, wherein a mutual loading of the touch panel driven in the mutual all drive way by the touch detection circuitry is less than a self loading of the touch panel driven in a self-driving way by the touch detection circuitry.

12. The touch panel driving system of claim 11, wherein a signal-to-noise ratio (SNR) of the touch panel driven in the mutual all drive way by the touch detection circuitry is larger than a SNR of the touch panel driven in the self-driving way by the touch detection circuitry.

13-14. (canceled)

15. The touch panel driving system of claim 10, wherein the first cycle is a different cycle from the second cycle.

16. The touch panel driving system of claim 10, wherein the ADC receives signals from the RX channels in response to the touch detection circuitry transmitting the signals to the TX channels.

17. The touch panel driving system of claim 16, wherein the ADC receives signals from the TX channels in response to the touch detection circuitry transmitting the signals to the RX channels.

18. The touch panel driving system of claim 17, wherein the RX channels are different from the TX channels.
